(19) United States
(12) Patent Application Publication
(10) Pub. No.: US 2019/0305409 A1
(43) Pub. Date: Oct. 3, 2019

(54) Millimeter Wave Antenna and Connection Arrangements

(71) Applicant: TE Connectivity Nederland BV, s'Hertogenbosch (NL)

(72) Inventors: Mohadig Widha Rousstia, Eindhoven (NL); Martinus E.J.J. Panis, Den Dungen (NL)

(73) Assignee: TE Connectivity Nederland BV, S'Hertogenbosch (NL)

(21) Appl. No.: 16/447,451

(22) Filed: Jun. 20, 2019

Related U.S. Application Data
(63) Continuation of application No. PCT/EP2017/083803, filed on Dec. 20, 2017.

(30) Foreign Application Priority Data
Dec. 23, 2016 (EP) 16206808.4

(51) Int. Cl. H01Q 1/38; H01Q 1/50; H01P 3/16; H01P 5/08

(52) U.S. Cl. CPC H01Q 1/38; H01P 5/087; H01P 3/16; H01Q 1/50

(57) ABSTRACT

An antenna comprises a pair of planar layers that are stacked in a direction perpendicular to a pair of layer planes along which the pair of planar layers extend and a separation layer at least partially separating the pair of planar layers. The pair of planar layers each end at a common layer end face and each provide a waveguide for transmission of electromagnetic waves parallel to the pair of layer planes. The waveguides end at the common layer face.

### CROSS-REFERENCE TO RELATED APPLICATIONS

This application is a continuation of PCT International Application No. PCT/EP2017/083803, filed on Dec. 20, 2017, which claims priority under 35 U.S.C. § 119 to European Patent Application No. 16206808.4, filed on Dec. 23, 2016.

### FIELD OF THE INVENTION

The present invention relates to an antenna and, more particularly, to an antenna for transmitting and/or receiving electromagnetic waves, in particular in the millimeter-wave frequency range.

### BACKGROUND

Antennas are used for transmitting and/or receiving electromagnetic waves, including in the millimeter-wave frequency range, especially for communication purposes. Such antennas generally require a large area and/or construction space. This complicates the integration of components into a system with a small amount of available space.

### SUMMARY

An antenna comprises a pair of planar layers that are stacked in a direction perpendicular to a pair of layer planes along which the pair of planar layers extend and a separation layer at least partially separating the pair of planar layers. The pair of planar layers each end at a common layer end face and each provide a waveguide for transmission of electromagnetic waves parallel to the pair of layer planes. The waveguides end at the common layer face.

### BRIEF DESCRIPTION OF THE DRAWINGS

The invention will now be described by way of example with reference to the accompanying Figures, of which:

FIG. 1 is a perspective view of a connection arrangement according to an embodiment in a transmission state;

FIG. 2 is a perspective view of a transmission member of the connection arrangement of FIG. 1;

FIG. 3 is a perspective view of a connection arrangement according to another embodiment in a transmission state;

FIG. 4 is a sectional perspective view of an antenna of the connection arrangement of FIG. 3;

FIG. 5 is a perspective view of the antenna of the connection arrangement of FIG. 3;

FIG. 6 is a perspective view of an antenna according to another embodiment; and

FIG. 7 is a perspective view of an antenna according to another embodiment.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. The various features shown in the embodiments may be used independently of each other in specific applications.

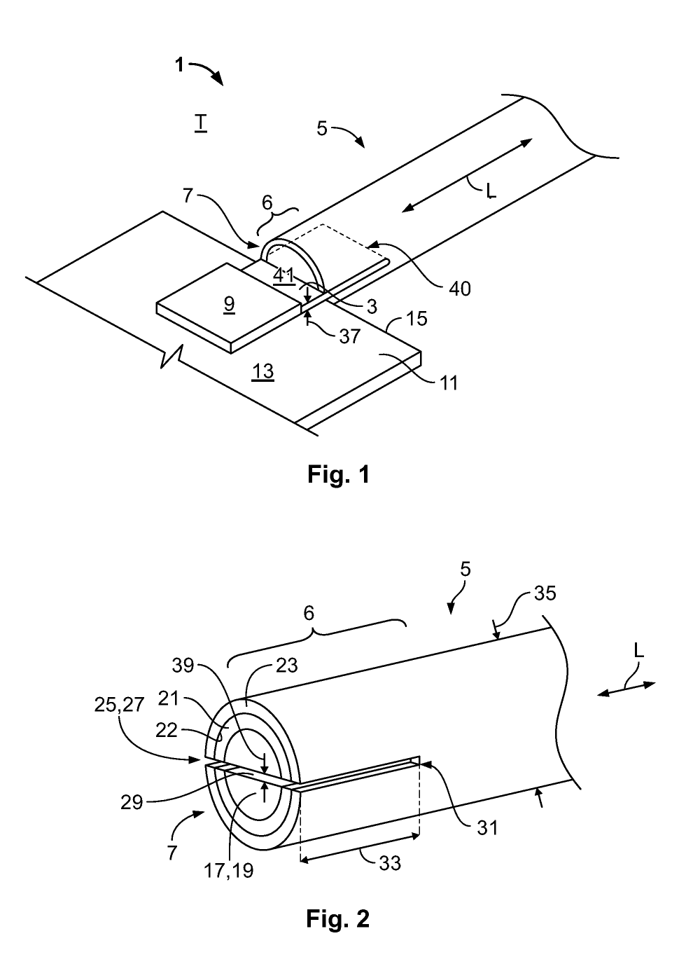

A connection arrangement 1 according to an embodiment is shown in FIG. 1. The connection arrangement 1 comprises an antenna 3 and a transmission member 5. The arrangement 1 is shown in a transmission state T in FIG. 1. In the transmission state T, the antenna arrangement 3 and the transmission member 5 are arranged such that electromagnetic waves can be coupled from the antenna 3 into the transmission member 5 and vice versa.

The transmission member 5, as shown in FIGS. 1 and 2, has an end section 6 with a free end 7. The end section 6 is connected to the antenna 3. The transmission member 5 has a second free end formed similar to the free end 7 and which may be connected to a similar antenna 3. In this embodiment, the connection arrangement 1 may comprise one transmission member 5 and two antennas 3.

As shown in FIG. 1, the antenna 3 is connected to at least one communication circuit 9 which may be a transmitter, a receiver, or a combined transceiver. In an embodiment, the antenna 3 is connected to a printed circuit board (PCB) 11 or monolithically integrated with the PCB 11. The antenna 3 is formed as PCB, in particular a low-loss PCB at millimeter-wave frequency range. The antenna 3 may be rigid or flexible.

In the shown embodiment, the antenna 3 has an overall rectangular flat shape indicated by the dashed line in FIG. 1. The rectangular shape extends parallel to or identical with a plane 13 of the PCB 11. The antenna 3 protrudes away from the PCB 11 along a longitudinal direction L, such that it extends beyond a front edge 15 of the PCB 11, such that a connection with the transmission member 5 is possible.

The transmission member 5 has an overall longitudinal shape and extends along the longitudinal direction L in the transmission state T, as shown in FIG. 1. In an embodiment shown in FIG. 2, at least a core 17 of the transmission member 5 is made from polymer fiber 19. In other embodiments, the core 17 may be made from other materials, in particular polymer materials, for example, foamed polymer material. In another embodiment, the core 17 may be made from materials such as glass. At least the core 17 is solid in an embodiment, except for the free ends where recesses may be present. In an embodiment, the transmission member 5 may be short and may form a cap for the antenna 3 to be connected to other waveguiding components.

As shown in FIG. 2, the core 17 may be surrounded along a circumferential direction by additional layers which can be chosen according to the required electric and/or mechanic properties. In particular, the layers may surround the core 17 in a sleeve-like manner. In an embodiment, the core 17 is surrounded by a dielectric layer 21, a shield 22, and an outer layer 23. In an embodiment, the dielectric layer 21 is made from a material with a dielectric constant that is lower than that of the core 17. The shield 22 is formed as a metallic shield 22 for signal confinement and the outer layer 23 may be made from plastic material for protection of the transmission member 5.

In the end section 6, as shown in FIG. 2, the transmission member 5 has a recess 25 which is formed as a slit 27. The recess 25 extends through a center 29 of the cross section of the transmission member 5. The cross section runs perpendicular to the longitudinal direction L. The recess 25 extends from the free end 7 into the transmission member 5 along the longitudinal direction L. The end of the recess 25 is formed by a bottom 31.

The transmission member 5 is laterally opened by the recess 25 in the end section 6, as shown in FIG. 2; the recess 25 also extends through the layers 21, 22 and 23. The openings in the layers 21, 22 and 23 are arranged diametrically to each other across the center 29. A penetration depth 33 of the recess 25 into the transmission member 5 is, in the first embodiment shown in FIG. 2, larger than an outer diameter 35 of the transmission member 5. In an embodiment, the penetration depth 33, which is measured from the free end 7 to the bottom 31 along the longitudinal direction L, is larger than 0% and up to 200% of the diameter 35.

The recess 25 is formed complementary to the antenna 3 such that the antenna 3 can be received in the recess 25 in the transmission state T, at least with its common layer end face 40, as shown in FIG. 1. In an embodiment, the antenna 3 abuts the bottom 31 in the transmission state T.

In another embodiment of the connection arrangement 1, the transmission member 5 may have a closed end 7 without a recess 25. In this case, the antenna 3 may abut the transmission member 5 with its common layer end face 40 instead of being inserted into the transmission member 5. It should also be noted that the antenna 3 may also be used without the transmission member 5 for wireless applications.

In an embodiment, a thickness 37 of the antenna is identical to a width 39 of the slit 27. The thickness 37 and the width 39 are measured perpendicular to the longitudinal direction L and perpendicular to the plane 41 of the antenna 3 in the transmission state T. The plane 41 of the antenna 3 is parallel to or identical with the plane 13 of the PCB 11. In the case that the thickness 37 and the width 39 are identical, the antenna 3 may be tightly fitted in the recess 25 such that no or only a very small amount of a surrounding medium such as air is present between the antenna 3 and the material of the core 17 in the transmission state T. It should be noted that “being identical” includes typical deviations due to the production, which may sum up to around 5% of the thickness 37 and or the width 39. The thickness 37 of the antenna 3 is less than 25% of the diameter 35 of the transmission member 5 in this embodiment.

In the transmission state T, the plane 41 of the antenna 3 extends parallel to the longitudinal direction L. The antenna 3 and the transmission member 5 are arranged along the same axis, which is defined by the longitudinal direction L. This improves the signal transmission between the antenna 3 and the transmission member 5 and may reduce signal loss. Inserting the antenna 3 into the recess 25 of the transmission member 5 facilitates coupling of these components. Thereby, a compact design is achieved and the coupling performance between the antenna 3 and the transmission member 5 may be improved.

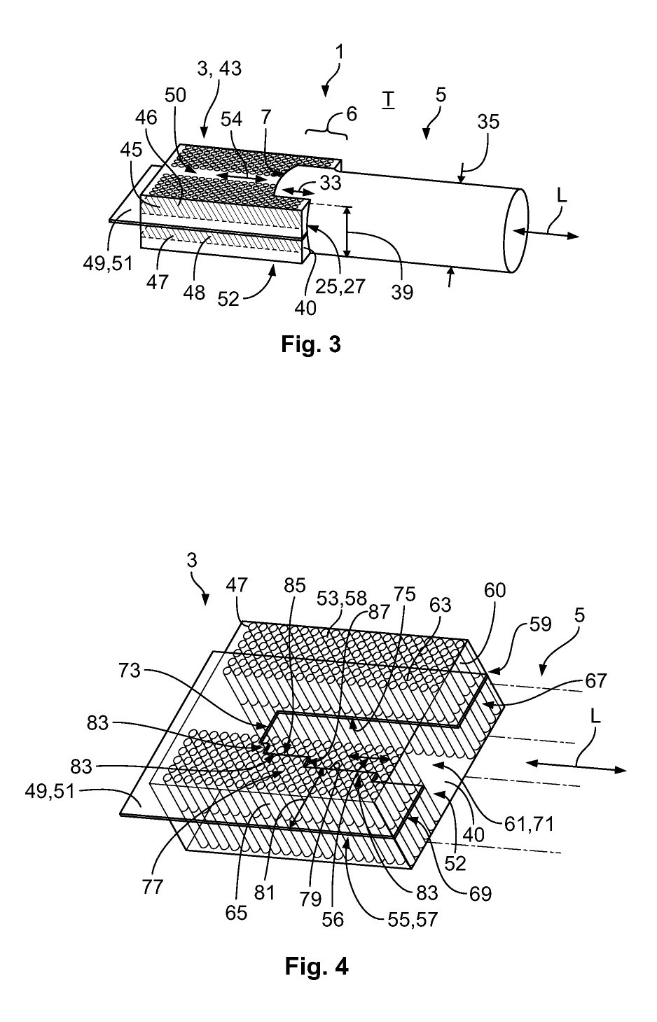

A connection arrangement 1 according to another embodiment is shown in FIGS. 3-5. An antenna 3 according to another embodiment is shown in FIGS. 3-5; the antenna 3 may be used in a connection arrangement 1 in which the antenna 3 abuts the transmission member 5 without being inserted into same, or in applications without the transmission member 5. Only the differences with respect to the aforementioned embodiments are described in detail herein.

As shown in FIG. 3, the recess 25, which is formed as a slit 27 has a penetration depth 33 which is smaller than 50% of the diameter 35 of the transmission member 5. Alternatively, the depth 33 may be larger than 0% and up to 200% of the diameter 35. The width 39 of the slit 27 is, in this embodiment, larger than the penetration depth 33. In an embodiment of a connection arrangement 1 in which the antenna 3 abuts the transmission member 5 without being inserted, the depth 33 is consequently 0% of the diameter 35.

The antenna 3, as shown in FIGS. 3-5, is formed as a printed circuit board 43 with two planar layers 45 and 47 and a separation layer 49, or septum. The separation layer 49 is formed as microstrip 51 in an embodiment. The separation layer 49, in various embodiments, is made from copper or metal which contains mostly copper. The layers 45 and 47 each extend along layer planes 46 and 48 (indicated by dashed lines in FIG. 3). Consequently, the separation layer 49 extends planar and parallel to the planes 46 and 48. The layers 45 and 47 are stacked perpendicular to the layer planes 46 and 48 and end at a common layer end face 40. In an embodiment, the common layer end face 40 extends perpendicular to the layer planes 46 and 48. The common layer end face 40 can be used as entrance for incoming and as exit for outgoing electromagnetic waves.

Each of the planar layers 45 and 47, as shown in FIGS. 3-5, provides a waveguide 50 and 52 for the transmission of electromagnetic waves parallel to the layer planes 46 and 48. The waveguides 50 and 52 are adapted for guiding electromagnetic waves along transmission directions 54 and 56 of the antenna 3. Consequently, the transmission directions 54 and 56 run parallel with the layer planes 46 and 48. In an embodiment, the transmission directions 54 and 56 extend perpendicular to the common layer end face 40. Since the common layer end face 40 is formed by the narrow sides of the layers 45 and 47, the common layer end face 40 has, at least in the direction perpendicular to the layers planes 46 and 48, a size which is in the range of the sum of the layer thicknesses. In an embodiment, the waveguides 50 and 52 have a constant cross-section along the transmission directions 54 and 56; the cross-section is defined perpendicular to the transmission directions 54 and 56.

Each of the waveguides 50 and 52 can be used for either incoming or outgoing electromagnetic radiation. Consequently, the antenna 3 can be used for full duplex communication. In an embodiment, in which the antenna 3 is coupled to a transmission member 5, either by abutting said transmission member 5 or by being inserted into a recess 25 of the transmission member 5, the longitudinal direction L of the transmission member 5 extends parallel with the transmission directions 54 and 56.

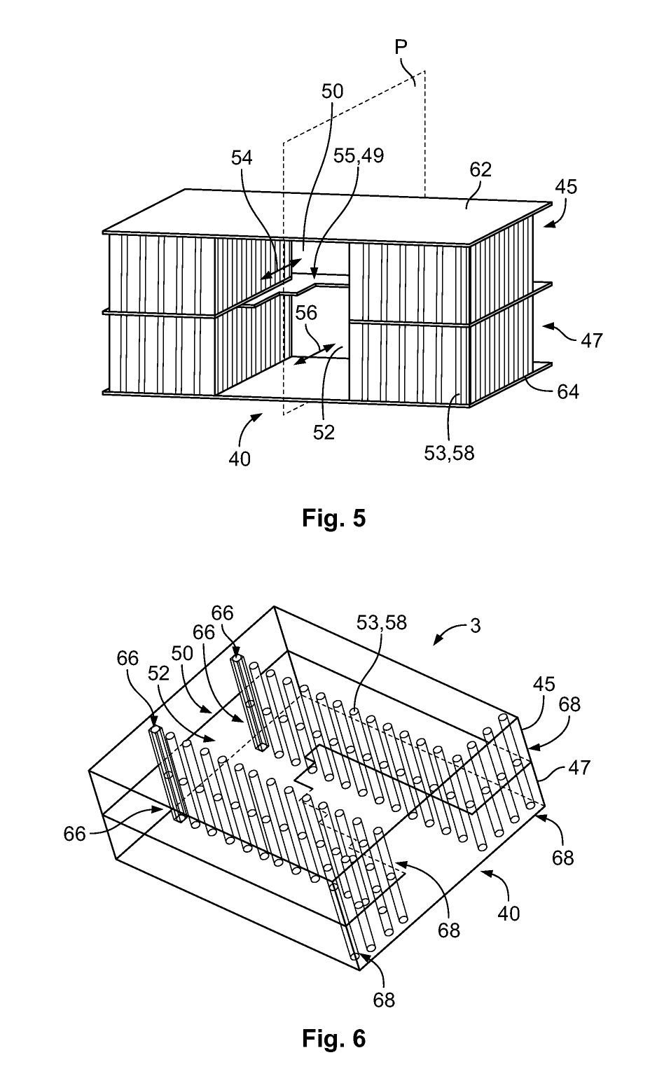

For guiding electromagnetic waves laterally, wherein laterally means perpendicular to the transmission directions 54 and 56, each waveguide 50 and 52 is bordered by lateral guiding elements 58, as shown in FIGS. 4 and 5. The layers 45 and 47 are provided with a plurality of through holes, or vias, 53 as lateral guiding elements 58. At least one lateral guiding element 58 may be made from a material having a dielectric constant which is different from that of the planar layers 45 and 47. The through holes 53 can be used for adjusting the electromagnetic properties of the antenna 3. The through holes 53 basically extend perpendicular to the longitudinal direction L and to the layer planes 46 and 48. The through holes 53, in an embodiment, are provided with metalized inner walls 60. In the embodiment of the antenna 3 as shown in FIGS. 3-5, each waveguide 50 and 52 is bordered by a plurality of through holes 53 on each side perpendicular to the transmission directions 54 and 56.

The separation layer 49 comprises a structure which is capable of polarizing electromagnetic radiation which is emitted from the antenna 3. The antenna 3 is therefore provided with a polarizing element 55. In an embodiment, the polarizing element 55 is a circular polarizer 57 as shown in FIG. 4. The polarizing element 55 is formed as an asymmetry in the shape of the separation layer 49. The asymmetry is seen with respect to a plane P of mirror symmetry extending parallel with the transmission directions 54 and 56 and perpendicular to the layer planes 46 and 48. The plane P of mirror symmetry is indicated by dashed lines in FIG. 5. The polarizing element 55 is adapted to differently polarize electromagnetic waves in the waveguides 50 and 52.

The structure capable of polarizing electromagnetic radiation has an overall U-shape 59, as shown in FIG. 4, which is formed as a recess 61 which extends from the common layer end face 40 into the separation layer 49 parallel to the transmission directions 54 and 56. The U-shape comprises a first leg 63 and a second leg 65 which extend parallel to the transmission directions 54 and 56, wherein free ends 67 and 69 of the legs 63 and 65 point in the direction of the common layer end face 40. The free space 71 between the legs 63 and 65, which is formed by the recess 61, tapers from the free ends 67 and 69 towards the bottom 73 of the U-shape 59 parallel to the transmission directions 54 and 56. Thereby, the first leg 63 comprises an inner side 75 which runs basically parallel to the transmission directions 54 and 56. The opposite second leg 65 comprises a stepped structure 77 on its inner side 79 such that a width 81 of the second leg 65 stepwise increases from the free end 69 towards the bottom 73. The width 81 of the leg 65 is measured perpendicular to the transmission directions 54 and 56 and in the plane of the separation layer 49.

Each of the steps 83, as shown in FIG. 4, has a first edge 85 and a second edge 87, which are arranged perpendicular to each other. The first edge 85 basically extends parallel with the transmission directions 54 and 56 and, consequently, the second edge 87 basically extends perpendicular to the transmission directions 54 and 56. The lengths of the first edges 85 increases for each step 83 parallel to the transmission directions 54 and 56 from the bottom 73 towards the free end 69.

In the embodiment, in which the antenna 3 is inserted into the recess 25 of the transmission member 5, the polarizing element 55 is at least partially inserted in the recess 25 in the transmission state T.

In order to improve the wave guiding properties of the waveguides 50 and 52, the layers 45 and 47 are both covered with metallic cover layers 62 and 64, as shown in FIG. 5. The cover layers 62 and 64 help to confine electromagnetic waves in the layers 45 and 47. The cover layers 62 and 64 are made transparent in FIGS. 3 and 4 for better visibility of the remaining components of the antenna 3. In an embodiment, the cover layers 62 and 64 can be made from a material having a dielectric constant which is different from that of the planar layers 45 and 47.

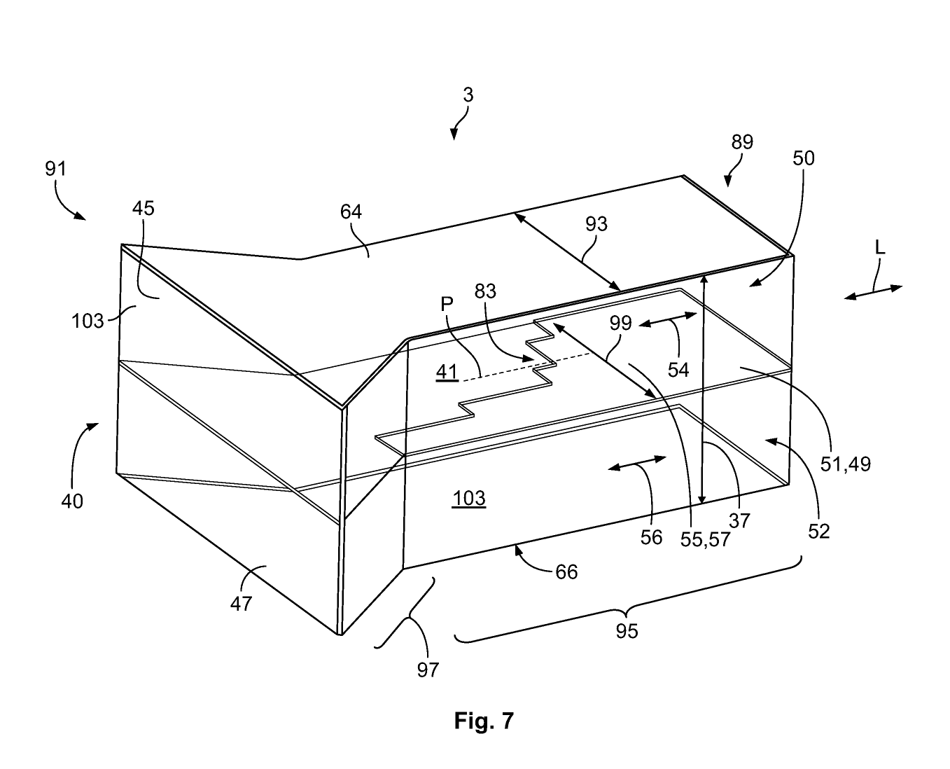

An antenna 3 according to another embodiment of the invention is shown in FIG. 6. Only the differences from the aforementioned embodiments will be described in detail herein. The antenna 3 differs from the embodiments as described before in that the lateral guiding elements 58 are formed by through holes 53 which are arranged in a single row 66 on each lateral side of the waveguides 50 and 52. At the common layer end face 40, front rows 68 of through holes 53 extend in each layer 45 and 47 on both lateral sides of the waveguides 50 and 52. The front rows 68 extend parallel with the common layer end face 40. The planar layers 45 and 47 are made transparent here for a better visibility.

An antenna 3 for a connection arrangement 1 according to another embodiment is shown in FIG. 7. The antenna 3 may, for example, be used in the arrangement 1 as described with respect to FIGS. 3 and 4. The antenna 3 may also be used in an embodiment of a connection arrangement 1 in which the antenna 3 abuts the transmission member 5 with the common layer end face 40 instead of being inserted into the transmission member 5. Furthermore, the antenna 3 may also be used without the transmission member 5, for example in wireless applications. Only the differences to the aforementioned embodiments are described in detail herein.

The antenna 3, as shown in FIG. 7, has an overall longitudinal shape extending along the longitudinal direction L. In the longitudinal direction L, the antenna 3 has a connection end 89 and a front end 91. The connection end 89 can be used for connecting the antenna 3 to a communication circuit 9.

The front end 91, as shown in FIG. 7, comprises the common layer end face 40 and can be used for being coupled to a transmission member 5. In particular, the front end 91 can be used for being coupled to a transmission member 5 as described with respect to FIGS. 3 and 4 either by being inserted into same or abutting a transmission member 5 which is not provided with a recess 25.

The antenna 3 has a constant thickness 37 along the longitudinal direction L. However, a width 93 of the antenna 3 varies along the longitudinal direction L. The width 93 of the antenna 3 is measured perpendicular to the longitudinal direction L and perpendicular to the direction of the thickness 37. The width 93 of the antenna 3 varies such that a first section 95 is formed, which has a constantly shaped cross section along the longitudinal direction L. In other words, the width 93 and the thickness 37 of the antenna 3 remain constant along the longitudinal direction L in the first section 95. The first section 95 starts at the connection end 89 and extends in the direction of the front end 91.

In a second section 97 of the antenna 3, as shown in FIG. 7, the width 93 of the antenna 3 varies along the longitudinal direction L. Thereby, the width 93 varies such that it is larger than in the first section 95 at the front end 91 and decreases towards the first section 95. In other words, the antenna 3 and its waveguides 50 and 52 broaden towards the common layer end face 40 in the second section 97. Seen along the direction of the thickness 37 of the antenna 3, the antenna 3 thereby has an overall funnel-like shape. By varying the cross section, the directional radiation characteristic for outgoing waves can be tuned. If the waveguides 50 and 52 broadens towards the common layer end face 40, the outgoing waves may be emitted within a smaller angle. Further, the antenna gain may be increased.

As in the embodiments described with respect to FIGS. 3 to 6, the antenna 3 in the embodiment shown in FIG. 7 comprises two planar layers 45 and 47 and a separation layer 49, which is arranged between the planar layers 45 and 47. The planar layers 45 and 47 are made from a dielectric material in an embodiment, for example the material of a printed circuit board, such as liquid crystal polymers (LCP), Teflon, or FR-4 epoxy resin systems.

The separation layer 49 comprises a polarizing element 55, in particular a circular polarizer 57 which is formed as a microstrip 51. The circular polarizer 57 comprises steps 83 which form a step structure 77. A width 99 of the circular polarizer 57 decreases with every step 83 in the longitudinal direction L towards the second section 97. In other words, the polarizer 57 is basically shaped as the second leg 65 as described with respect to FIG. 4. The polarizing element 55 is also here formed by an asymmetry in the shape of the separation layer 49. Hereby, the plane of mirror symmetry extends along the longitudinal direction L and perpendicular to the layer planes 46 and 48 or, in other words to the plane 41 of the antenna 3. In FIG. 7 a dashed line indicates where the plane P cuts the separation layer 49. In an embodiment, the polarizing element 55 is formed monolithically with the separation layer 49.

Circular polarization allows rotational freedom of the antenna 3 with respect to a rotation around the transmission direction and allows full duplex communication. One waveguide 50 and 52 can be used for outgoing electromagnetic waves, which have, just by way of example, right hand circular polarization. If electromagnetic waves are received, which have left hand circular polarization, then these waves will be guided into the second waveguide 50 and 52 upon entering the antenna 3 through the common layer end face 40. Consequently, both waveguides 50 and 52 can be used at the same time which enables the full duplex communication.

The planar layers 45 and 47 are not provided with vias or through holes 53 as the embodiments described above. Instead, the antenna 3 of FIG. 7 comprises metalized sidewalls 103. The sidewalls 103 are arranged opposite to each other along the direction of the width 93 of the antenna 3. Consequently, the sidewalls 103 extend parallel with each other in the first section 95 and diverge in the second section 97. The sidewalls 103 are either be made from a metallic material or from a material having a dielectric constant which is different from that of the planar layers 45 and 47.

As shown in FIG. 7, the planar layers 45 and 47 are covered with metallic cover layers 62 and 64 on top and bottom of the antenna 3. The metallic cover layers 62 and 64 are arranged parallel with each other and extend parallel with the direction of the width 93 of the antenna 3 and the longitudinal direction L.

What is claimed is:

1. An antenna for transmitting and/or receiving electromagnetic waves, comprising:
a pair of planar layers that are stacked in a direction perpendicular to a pair of layer planes along which the pair of planar layers extend, the pair of planar layers each end at a common layer end face and each provide a waveguide for transmission of electromagnetic waves parallel to the pair of layer planes, the waveguides end at the common layer face; and
a separation layer at least partially separating the pair of planar layers.

2. The antenna of claim 1, wherein the separation layer is a metallic material.

3. The antenna of claim 1, wherein the pair of planar layers are each at least partially covered with a metallic cover layer.

4. The antenna of claim 1, wherein the waveguide of each of the pair of planar layers is bordered by a plurality of lateral guiding elements.

5. The antenna of claim 4, wherein at least one of the lateral guiding elements is a material having a dielectric constant which is different from that of the pair of planar layers.

6. The antenna of claim 4, wherein at least one of the lateral guiding elements is a metallic material.

7. The antenna of claim 4, wherein at least one of the lateral guiding elements is a through hole in one of the pair of planar layers.

8. The antenna of claim 7, wherein the through hole extends perpendicular to the pair of planar layers.

9. The antenna of claim 4, wherein at least one of the lateral guiding element is a side wall extending perpendicular to the pair of layer planes and along the waveguide.

10. The antenna of claim 1, wherein the waveguide of at least one of the pair of planar layers broadens toward the common layer end face in a direction parallel to the pair of layer planes.

11. The antenna of claim 1, further comprising a polarizing element adapted to differently polarize electromagnetic waves in the waveguide of each of the pair of planar layers.

12. The antenna of claim 11, wherein the polarizing element is formed monolithically with the separation layer.

13. The antenna of claim 12, wherein the polarizing element is formed as an asymmetry in a shape of the separation layer.

14. The antenna of claim 13, wherein the asymmetry is formed by a stepped structure in the separation layer.

15. A connection arrangement for the transmission and reception of electromagnetic waves, comprising:
an antenna including a pair of planar layers that are stacked in a direction perpendicular to a pair of layer planes along which the pair of planar layers extend and a separation layer at least partially separating the pair of planar layers, the pair of planar layers each end at a common layer end face and each provide a waveguide for transmission of electromagnetic waves parallel to the pair of layer planes, the waveguides end at the common layer face; and
a transmission member adapted to transport the electromagnetic waves, the transmission member abuts the common layer end face in a transmission state.

16. A connection arrangement for the transmission and reception of electromagnetic waves, comprising:
an antenna including a pair of planar layers that are stacked in a direction perpendicular to a pair of layer planes along which the pair of planar layers extend and a separation layer at least partially separating the pair of planar layers, the pair of planar layers each end at a common layer end face and each provide a waveguide for transmission of electromagnetic waves parallel to the pair of layer planes, the waveguides end at the common layer face; and
a transmission member adapted to transport the electromagnetic waves, the transmission member has a recess extending from a free end of the transmission member into the transmission member, the common layer end face is at least partially inserted into the recess in a transmission state.
